(19) United States
(12) Patent Application Publication
(10) Pub. No.: US 2011/0006742 A1
(43) Pub. Date: Jan. 13, 2011

(54) Dynamic Energy Harvesting Control

(75) Inventors: Ross Teggatz, McKinney, TX (US); Wayne Chen, Plano, TX (US); Amer Atrash, Richardson, TX (US); Brett Smith, McKinney, TX (US); Eric Blackall, Richardson, TX (US)

Correspondence Address: MICHAEL T. KONCZAL, PATENT ATTORNEY, P.O. BOX 863656, PLANO, TX, 75086, US

(73) Assignee: TRIUNE IP LLC, Richardson, TX (US)

(21) Appl. No.: 12/833,997

(22) Filed: Jul. 11, 2010

Related U.S. Application Data
(60) Provisional application No. 61/224,857, filed on Jul. 11, 2009.

(51) Int. Cl. G05F 1/10

(52) U.S. Cl. 323/234

(57) ABSTRACT

The invention provides control methods and systems for harvesting energy from a variable-output power apparatus. One or more variable-output power elements configured for producing energy are used as input to a power regulation circuit operably coupled between the power elements and a load. One or more power signals in the circuit are monitored and the power regulation circuit output is dynamically adjusted based on the one or more monitored power signals. According to aspects of the invention, the output duty cycle or frequency may be adjusted in response to monitored parameters.

### PRIORITY ENTITLEMENT

This application is entitled to priority based on Provisional Patent Application Ser. No. 61/224,857 filed on Jul. 11, 2009. This application and the Provisional patent application have at least one common inventor.

### TECHNICAL FIELD

The invention relates to electronic systems for the more efficient utilization of energy resources. More particularly, the invention relates to power control methods, systems, and circuitry designed to facilitate the harvesting of useable power from variable power energy sources such as photovoltaic systems. Systems using the invention include a power regulation circuit configured for monitoring conditions relating to power parameters, and for dynamically adjusting the frequency and/or duty cycle of the power supply responsive to the relationship between power output and load.

### BACKGROUND OF THE INVENTION

Systems for harvesting energy from renewable resources have long been desired in the arts. One of the problems associated with engineering energy harvesting systems is the challenge of making maximum use of energy sources which may be intermittent in availability and/or intensity. Unlike traditional power plants, alternative energy sources tend to have variable outputs. Solar power, for example, typically relies on solar cells, or photovoltaic (PV) cells, used to power electronic systems by charging storage elements such as batteries or capacitors, which then may be used to supply an electrical load. The sun does not always shine on the solar cells with equal intensity however, and such systems are required to operate at power levels that may vary depending on weather conditions, time of day, shadows from obstructions, and even momentary shadows cast by birds passing overhead, causing solar cell power output to fluctuate. Similar problems with output variability are experienced with other variable-output power sources such as wind, piezoelectric, regenerative braking, hydro power, wave power, and so forth. It is common for energy harvesting systems to be designed to operate under the theoretical assumption that the energy source is capable of delivering at its maximum output level more-or-less all of the time. This theoretical assumption is rarely matched in practice.

Switch mode power supplies (SMPS) are commonly used in efforts to efficiently harvest intermittent and/or variable energy source output power for delivery to storage element(s) and/or load(s). The efficiency of the SMPS generally is fairly high, so much so that the power output of the SMPS is often almost equal to the power input of the SMPS. Careful planning and device characterization are often used to attempt to design a system capable of harvesting at the theoretical maximum power level. In a PV system, for example, the maximum power output of a solar cell peaks at a load point specific to the particular solar cell. This maximum power output point varies across different individual solar cells, solar cell arrays, systems in which the solar cells are used, and the operating environment of system and solar cell. The maximum energy harvesting capability of the electronic system therefore depends on the solar cell characteristics the characteristics of the load applied to the solar cell. One example of a typical application is a portable electronic system to harvest energy from a solar cell in order to charge a battery. Battery charging systems commonly have multiple modes, which include fast charging, charging at full capacity (also called 1C charging), and trickle charging. A typical SMPS regulates output voltage and operates under the theoretical assumption that the power input is capable of delivering the maximum load requirements of the output. In practice, the output impedance of a PV cell is high, so as duty cycle changes, input voltage also changes, which changes the output power of the PV cell. Thus, there is a problem with efficiently exploiting the energy harvesting potential of PV systems and other power sources.

Due to these and other problems and potential problems with the current state of the art, improved methods, apparatus, and systems for energy harvesting would be useful and advantageous.

### SUMMARY OF THE INVENTION

In carrying out the principles of the present invention, in accordance with preferred embodiments, the invention provides advances in the arts with novel methods, systems, and apparatus for providing dynamic energy harvesting control.

According to one aspect of the invention, preferred embodiments include a method for harvesting energy from variable-output power apparatus with steps for providing a circuit having one or more variable-output power elements for producing energy and a power regulation circuit coupled between the power elements and a load. Further steps are included for monitoring one or more power signals in the circuit and dynamically adjusting the power regulation circuit output in response to the monitored signals.

According to another aspect of the invention, a preferred method for harvesting energy also includes steps for adjusting the power regulation circuit output by adjusting the output duty cycle.

According to still another aspect of the invention, in a preferred embodiment of the above-indicated method for harvesting energy, a step of adjusting the power regulation circuit output further includes steps for adjusting the output frequency.

According to another aspect of the invention, in a preferred embodiment thereof, a system for harvesting energy has a circuit with one or more variable-output power sources for providing energy input. A power regulation circuit such as a switched mode power supply is connected with the variable-output power source and a load. A monitor is provided for the purpose of monitoring one or more power signals in the circuit. A control module is provided for dynamically adjusting the switched mode power supply responsive to the monitored signals.

According to another aspect of the invention indicated above, a variable-output power source of the system is provided in the form of a photovoltaic energy harvesting device.

According to another aspect of the invention indicated above, a variable-output power source of the system is provided in the form of an electromechanical generator device.

The invention has advantages including but not limited to one or more of the following, enhanced energy harvesting control, improved efficiency, and reduced costs. These and other advantageous features and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified schematic diagram illustrating a power source, power regulation circuit, and load in an example of a preferred embodiment of systems and methods of the invention;

FIG. 2 is a simplified schematic diagram of an example of a preferred embodiment of systems and methods of the invention, depicting a power source, switched mode power supply, and load;

FIG. 3 is a simplified schematic diagram of an example of a preferred embodiment of systems and methods of the invention, showing a power source array, switched mode power supply, and load;

FIG. 4 is a simplified schematic diagram of another example of a preferred embodiment of systems and methods of the invention, depicting a power source, switched mode power supply, and load;

FIG. 5 is a simplified schematic diagram of another example of a preferred embodiment of systems and methods of the invention;

FIG. 6 is a simplified schematic diagram of another example of systems and methods of the invention, illustrating a preferred embodiment including a power source array, switched mode power supply, and load array; and

FIG. 7 is a simplified schematic diagram of an example of a preferred alternative embodiment of systems and methods of the invention.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features, as well as advantages of the invention.

### DESCRIPTION OF PREFERRED EMBODIMENTS

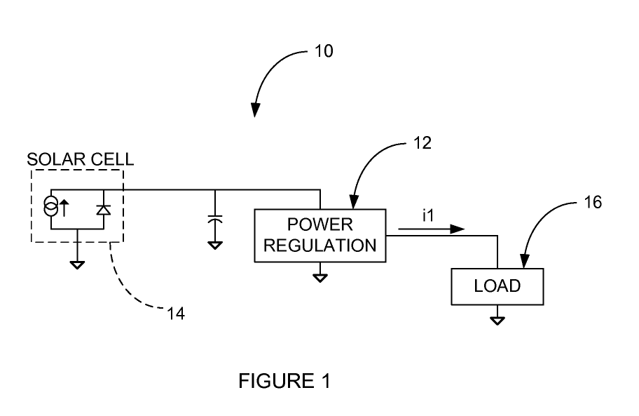

While the making and using of various exemplary embodiments of the invention are discussed herein, it should be appreciated that the present invention provides inventive concepts which can be embodied in a wide variety of specific contexts. It should be understood that the invention may be practiced with various power sources such as photovoltaics as well other alternative energy harvesting devices. For example, in some applications it maybe desirable to use power sources such as wind, piezoelectric, thermal, or other energy sources in various combinations with or as an alternative to solar, which may be accomplished employing the principles of the invention. For purposes of clarity, detailed descriptions of functions, components, and systems familiar to those skilled in the applicable arts are not included. In general, the invention provides techniques and apparatus for energy harvesting with dynamic matching of output and load. Preferably, in order to provide beneficial gains in energy harvesting, the energy-harvesting power supply should have its duty cycle modulated such that it delivers the maximum current to the load, which can be a storage device such as a battery or capacitor, electronic load, or a combination. The preferred approach is to implement a control loop for a switched mode power supply (SMPS) coupled between the source(s) and load(s). In presently preferred embodiments, the SMPS modulates the duty cycle such that output current is the maximum the system can deliver, and is implemented in the preferred embodiments as either a buck or boost configuration. As an alternative to a SMPS implementation, other configurations of circuitry for regulating power systems may also be used, such as, buck-boost, boost-buck, charge pump, Cuk converter, SEPIC (single-ended primary-inductor converter), Zeta converter, and possibly others. Referring primarily to FIG. 1, a simplified schematic diagram shows a system 10 in which a power regulation circuit 12, such as a switched mode power supply (SMPS), is coupled to an energy harvesting device, in this exemplary embodiment a photovoltaic (PV) cell 14, although other devices or combinations of energy harvesting devices may be used. A load 16 is also coupled to the power regulation circuit 12. The power regulation circuit 12 controls the output current indicated by arrow i1 to the load 16. Preferably, this is accomplished by controlling the power regulation circuit 12 based upon data dynamically obtained by monitoring the current output i1 with a suitable sensor. The power-related parameters of the power regulation circuit 12 output current i1 may be monitored by one or more of a variety of techniques without departure from the scope of the invention. For example, as a proxy for current, a voltage sensor may alternatively be used in the appropriate location(s). Power-related parameters, such as voltage and current, are generally referred to herein as “power signals”. The monitored power signal, e.g., current, is used as the basis upon which the duty cycle, frequency, or both may be adjusted based on the previous control and current measurement. Thus, the output current delivered to the load (e.g., battery and/or electronic load) may be adjusted, which then in turn adjusts how much power is demanded from the energy harvesting device(s) (e.g., solar cell 14). The monitoring steps are preferably reiterated at a later time to either increase or decrease the duty cycle and/or frequency and measure the output current again. If the current were to increase, indicating the capability of the solar cell to provide more power, the duty cycle would repeat the increase again to make use of this additional power. If the current were to decrease, indicating that the power producing capability of the solar cell were being exceeded, the duty cycle would decrease to reduce the power supplied to the load.

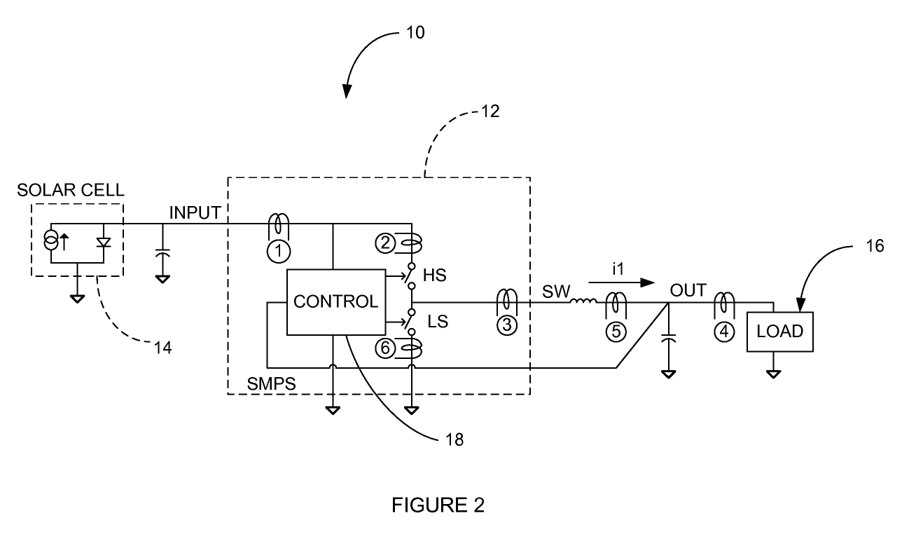

Now referring primarily to FIG. 2, an example of a preferred embodiment of a system 10 is depicted in which the power regulation circuit, an SMPS 12, is shown to include a control module 18. One or more sensors for monitoring the current, voltage, or other power-related parameters, are provided at one or more locations. For example, the current, indicated by arrow i1, may be sensed and monitored at the supply input to the SMPS block 12, denoted location 1. A power signal may also, or alternatively, be sensed and monitored at the high-side switch of the SMPS 12, denoted location 2. The power signal may also, or alternatively, be sensed and monitored at the output of the SMPS 12, denoted location 3. The power signal may also, or alternatively, be sense and monitored at the load, denoted location 4. The power signal may also, or alternatively, be sensed and monitored at the feedback side of inductor terminal, denoted location 5. The power signal may also, or alternatively, be sensed and monitored at the low side switch, denoted location 6. The power parameter(s), in this example current, thus monitored is used in the performance of an algorithm in the control module, which adjusts upwards/downwards the SMPS 12 output duty cycle, frequency, or both, based on the previous control setting(s) and/or monitored power signal measurement(s) to adjust the output delivered to the load 16, e.g., storage element, battery and/or electronic apparatus, in turn adjusting how much power demand is placed on the energy harvesting device 14. Preferably, the control algorithm iteratively re-checks and can initiate an increase, decrease, or continuation of the duty cycle and/or frequency. If the monitored current is found to have increased, indicating that the energy harvesting device, in this case a PV cell, has the capability to provide more power, the duty cycle repeats the increase again to make use of this additional power. If the monitored current is found to have decreased, indicating that the PV cell is beyond its power capability, the duty cycle decreases to reduce the power supplied to the load. This cycle may be reiterated any number of times, the duty cycle and/or frequency adjustment repeating the previous adjustment for an increase in current measurement, or alternatively adjusting the duty cycle in the opposite direction in the event the current measurement decreases.

In another exemplary embodiment, with continued reference to FIG. 2, the SMPS input voltage and/or input current are preferably monitored at location 5, and the control module is used to dynamically adjust the SMPS based upon monitored conditions to maximize the input power. Using the monitored input current and the voltage on the input supply, the control module may be used to calculate the power output from the PV cell to the SMPS. This circuit configuration and method preferably keeps the PV cell operating at or near its peak power output. In another alternative embodiment, a power signal, e.g., current, level at the load, e.g., a rechargeable energy storage device, may be monitored and provided as feedback to the SMPS control module during operation in a constant-current charging mode. An example of monitoring a battery current is shown at location 4 in FIG. 2. The duty cycle and/or frequency of the control loop are preferably adjusted to provide up to 1C charging current to the battery. If the solar cell is capable of supplying more than 1C charging current, then the SMPS limits the current to the battery to a 1C current level for battery protection. If 1C charging current cannot be supplied from the solar cell, then the solar cell provides maximum peak power. This is achieved by setting the duty cycle addressed to the output such that the maximum power is presented to the battery load. The equation for a SMPS output is, Pₒᵤₜ=(Efficiency*Pᵢₙ). As expressed in the equation of the SMPS and the maximum power to the load, input power is maximized. This control mechanism preferably is responsive to monitored charging current and does not require feedback relating to bias conditions or characteristics of the solar cell, such as temperature or forward voltage drop. It is contemplated within the scope of the invention that the 1C charge may be monitored in various selected locations, such as at the power regulator input 1, high side switch 2, power regulator output terminal 3, load 4, feedback side of inductor terminal 5, and low side switch 6. In a PV system, the 1C charging current is preferably monitored through the battery, and the load is also supplied through the system while charging, then the maximum charging current can be increased to (1C+Iload), where Iload is the additional current supplied to the load. It should be appreciated that in principle any number N and type of energy harvesting devices, elements, or arrays may be used within the scope of the invention.

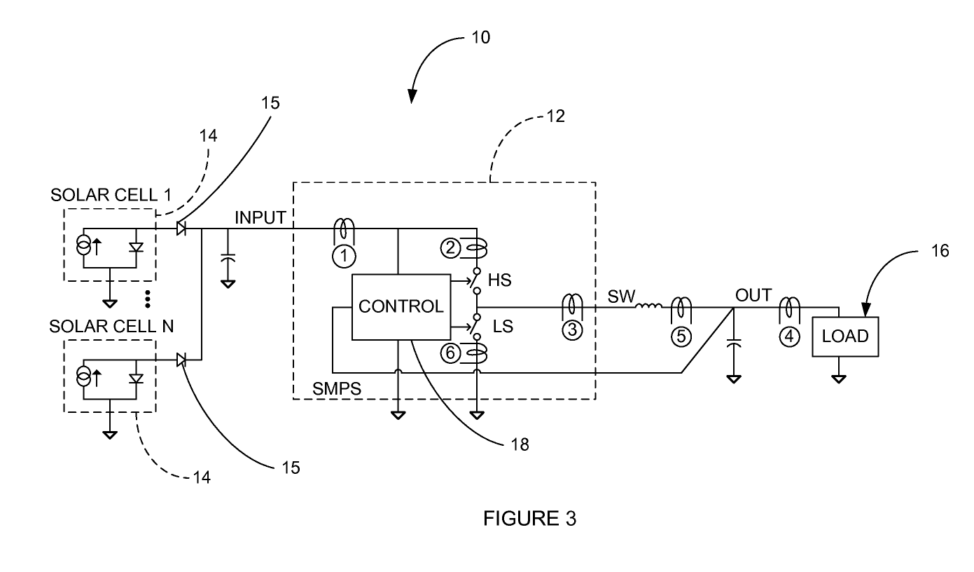

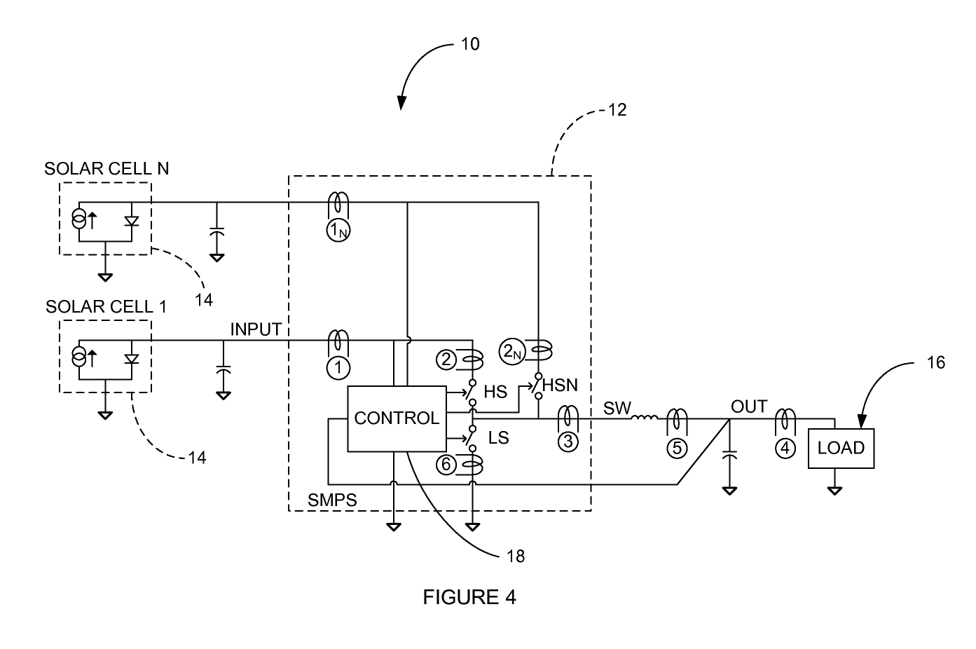

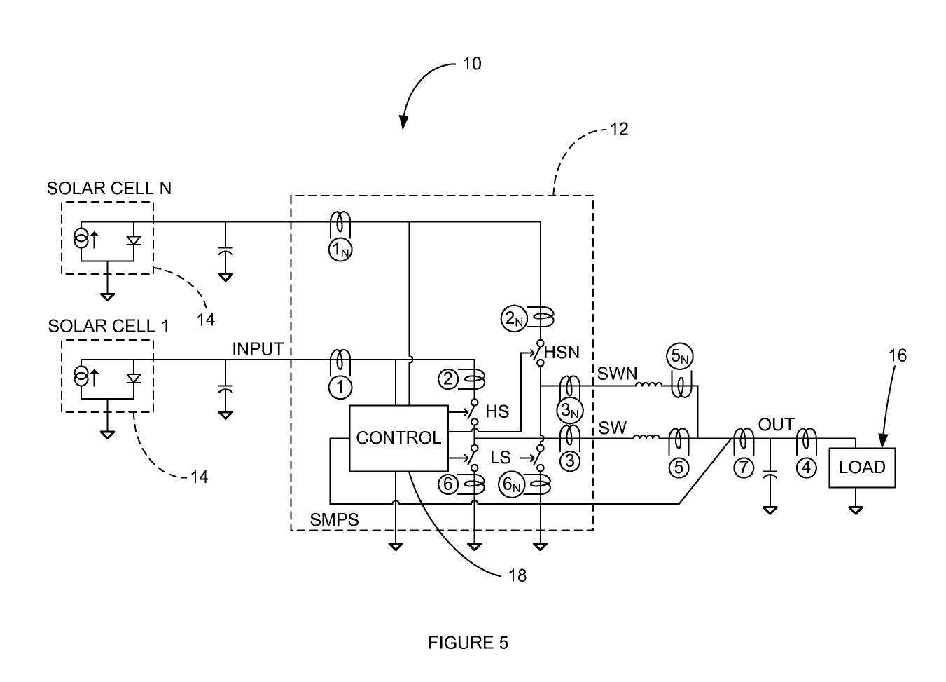

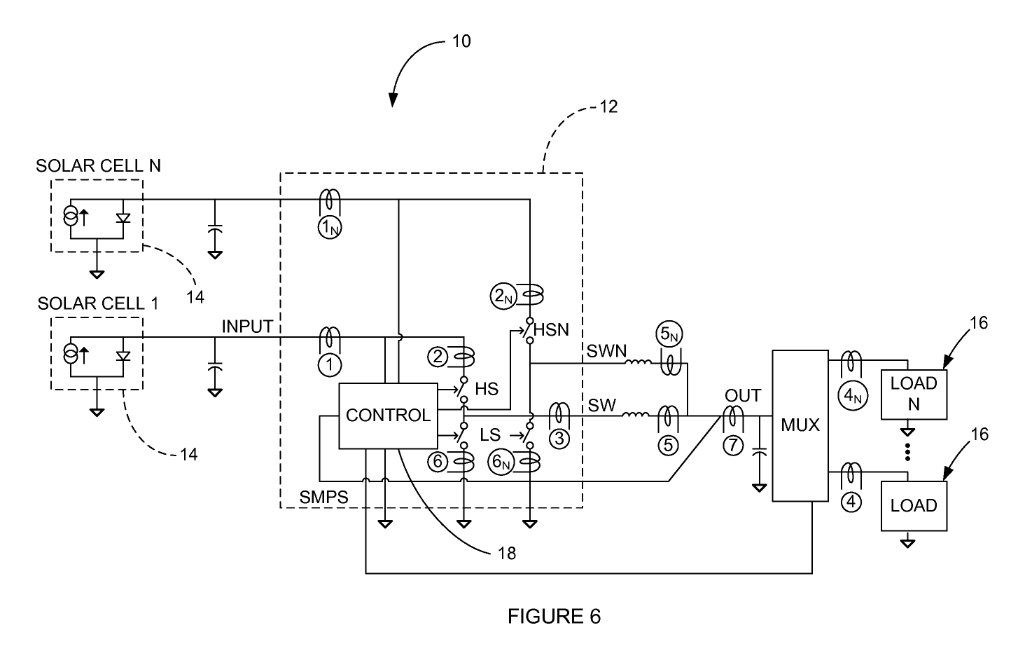

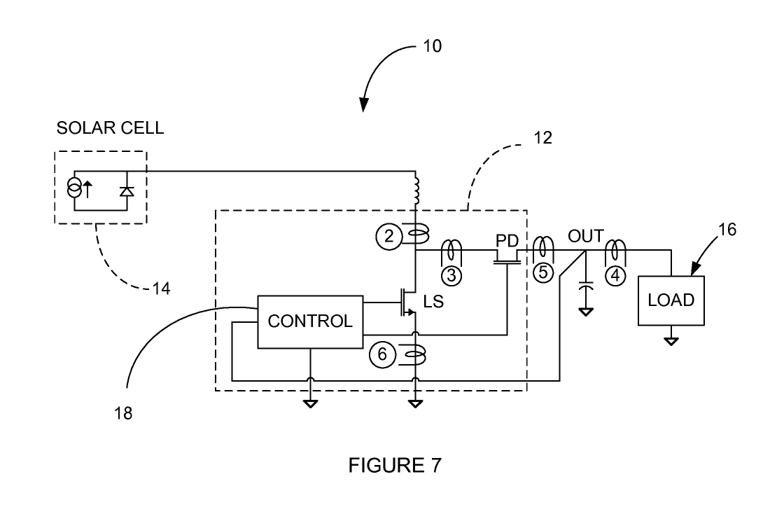

In an example of another preferred embodiment of a dynamic energy harvesting control, FIG. 3 illustrates a system with an array of N multiple solar cells providing a source of power for a charging system. This implementation utilizes blocking diodes 15 to prevent one solar cell from loading another in the case when one solar cell is exposed to light and the other cell is blocked from receiving light. However, a drawback of this configuration is that the blocking diodes are additional power-loss elements, and hence the solar cell cannot achieve its maximum possible power production efficiency. Using this topology, in another alternative embodiment, active switches are preferably substituted in place of the blocking diodes 15, eliminating diode power loss and reducing overall loss of power loss to losses incurred due to the impendence of the switches. An alternative implementation avoiding the use of blocking diodes is illustrated in FIG. 4. This implementation utilizes the active switch as part of the switched mode charging system. In this mode the control system can monitor real-time individual solar cell power as well as total output power provided to the battery. This has downsides because the N solar cells have to be independently switched into the charging system. As a result, care must be taken in storing charge at the solar cell in order to assure that maximum power can be achieved with respect to each solar cell load. One way of achieving this is providing a complex load comprised of inductors and capacitors which can store the energy while the respective solar cell is in a state waiting to transfer power. FIG. 5 shows an implementation in which complex loads are directly utilized in the control loop, which allows each of the N solar cells to be continuously monitored and utilized. In this configuration, power signals may be monitored at various locations as described (e.g., locations 1-6), additionally, as shown at location 7, a single sensing element that provide measurement for the multiple inductor outputs. Other implementations can be utilized by providing switches at the output where a plurality of loads and/or batteries can be charged. A sequential state machine can be used to control the charging of these multiple batteries/loads. This is shown in FIG. 6. In order for the solar cells to operate in an efficient manner, and therefore at peak power, it is preferred for the output load seen at the solar cell output to be a continuous load. In order to achieve this in a system where a switching charge and control circuit is being utilized, a circuit interface is placed between the output of the solar cell and the supply input to the switches. One implementation of this is to provide a complex filter component, which can be comprised of one or more inductors and capacitors. Alternatively, another approach is to use an active circuit. This example is shown with a multiplexor, denoted MUX, provided for switching between and among N loads, dynamically adapting the output of the energy harvesting devices 14 based on changing power levels and load conditions. There are many variations possible within the scope of the invention, all of which cannot, and need not, be shown. A further example of an alternative implementation is illustrated in FIG. 7. In this example, the topology of the power regulation block 12 is a boost converter, which has the characteristic of providing an output voltage that is higher than the input voltage. To achieve this function, the low-side switch LS is turned-on for a duration of time, allowing current in the inductor to increase. Once a predetermined current level has been reached, then the LS is turned-off, and the pass device PD is turned-on, allowing current to flow out of SMPS 12. This increases the voltage of the OUT node. The voltage from the energy harvesting device 14 is monitored and evaluated with respect to the power signal monitored at the output 5. A power signal may also, or alternatively, be sensed and monitored at the circuit side of the inductor, denoted location 2. The power signal may also, or alternatively, be sensed and monitored at the output of the SMPS 12, denoted location 3. The power signal may also, or alternatively, be sense and monitored at the load, denoted location 4. The power signal may also, or alternatively, be sensed and monitored at the low side switch, denoted location 6. The control circuit 18 is then used to adjust the duty cycle. The monitored relationship is then checked again, and the duty cycle may again be adjusted in an iterative process to optimize input and output. Further embodiments may also include multiple PV cell inputs, multiple electronic loads, and multiple LS and pass device switches.

The methods and apparatus of the invention provide one or more advantages including but not limited to improved energy harvesting power control and efficiency. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. A method for harvesting energy from a variable-output power apparatus comprising:
providing a circuit having one or more variable-output power elements for producing energy input, the circuit having a power regulation circuit operably coupled between the power elements and a load;
monitoring one or more power signals in the circuit; and dynamically adjusting the power regulation circuit output based on the one or more monitored power signals.

2. A method for harvesting energy according to claim 1 wherein the step of adjusting the power regulation circuit output further comprises adjusting the output duty cycle.

3. A method for harvesting energy according to claim 1 wherein the step of adjusting the power regulation circuit output further comprises adjusting the output frequency.

4. A method for harvesting energy according to claim 1 wherein the step of monitoring one or more power signals in the circuit further comprises sensing a power signal at the load.

5. A method for harvesting energy according to claim 1 wherein the step of monitoring one or more power signals in the circuit further comprises sensing a power signal at the input to the power regulation circuit.

6. A method for harvesting energy according to claim 1 wherein the step of monitoring one or more power signals in the circuit further comprises sensing a power signal at the output from the power regulation circuit.

7. A system for harvesting energy comprising:
a circuit having one or more variable-output power sources for providing energy input and a power regulation circuit operably coupled to the variable-output power sources and a load;
at least one monitor for monitoring one or more power signals in the circuit; and
a control module for dynamically adjusting the power regulation circuit output based on the one or more monitored signals.

8. A system for harvesting energy according to claim 7 wherein the power regulation circuit further comprises a switched mode power supply.

9. A system for harvesting energy according to claim 7 wherein a variable-output power source further comprises a photovoltaic device.

10. A system for harvesting energy according to claim 7 wherein a variable-output power source further comprises an electromechanical generator device.

11. A system for harvesting energy according to claim 7 wherein a variable-output power source further comprises a piezoelectric device.

12. A system for harvesting energy according to claim 7 wherein a monitor further comprises a current sensor.

13. A system for harvesting energy according to claim 7 wherein a monitor further comprises a voltage sensor.

14. A system for harvesting energy according to claim 7 wherein the circuit further comprises a battery in parallel with the load.

15. A system for harvesting energy according to claim 7 wherein the circuit further comprises imaging apparatus.

16. A system for harvesting energy according to claim 7 wherein the circuit further comprises display apparatus.

17. A system for harvesting energy according to claim 7 wherein the circuit further comprises communication apparatus.

18. A system for harvesting energy according to claim 7 wherein the circuit further comprises audio apparatus.

19. A system for harvesting energy according to claim 7 wherein the circuit further comprises computing apparatus.

20. A system for harvesting energy according to claim 7 wherein the circuit further comprises sensor apparatus.

21. A system for harvesting energy according to claim 7 wherein the circuit further comprises transportation apparatus.

22. A circuit for controlling energy harvesting comprising:
one or more variable-output power sources configured for providing energy input to a power regulation circuit operably coupled to the variable-output power sources and a load;
at least one monitor for monitoring one or more power signals in the circuit; and
a control module for dynamically adjusting circuit output based on the one or more monitored signals, whereby the circuit is configured for harvesting optimal energy input provided by the one or more variable-output power sources.
